(19) United States
(12) Patent Application Publication
(10) Pub. No.: US 2026/0304524 A1
(43) Pub. Date: Oct. 1, 2026

(54) UHR PARAMETERS CRITICAL UPDATE SIGNALING

(71) Applicant: Cisco Technology, Inc., San Jose, CA (US)

(72) Inventors: Binita GUPTA, San Diego, CA (US); Brian D. HART, Sunnyvale, CA (US); Malcolm M. SMITH, Richardson, TX (US)

(21) Appl. No.: 19/635,092

(22) Filed: Mar. 31, 2026

Related U.S. Application Data
(60) Provisional application No. 63/792,492, filed on Apr. 22, 2025.
(60) Provisional application No. 63/780,980, filed on Mar. 31, 2025.

(51) Int. Cl. H04W 76/15

(52) U.S. Cl. CPC H04W 76/15

(57) ABSTRACT

The present disclosure relates to techniques for signaling ultra-high reliability (UHR) updates, including a method comprising implementing, at an affiliated access point (AP) of an AP multi-link device (MLD), a UHR Basic Service Set (BSS) for one or more non-AP MLDs. The method further includes receiving an indication of a critical update to a UHR mode of operation, the critical update affecting the affiliated AP. The method further includes, responsive to the indication, setting a value of a UHR critical update flag to announce a critical update, incrementing a UHR BSS Parameters Change Count (BPCC) value corresponding to the affiliated AP, encoding one or more management frames to include the UHR critical update flag and UHR critical update information field, the UHR critical update information field comprising the UHR BPCC value and a generation update type value and transmitting, by the affiliated AP, the one or more encoded management frames.

### CROSS-REFERENCE TO RELATED APPLICATIONS

This application claims benefit of co-pending United States provisional patent application Serial No. 63/780,980 filed Mar. 31, 2025, and co-pending United States provisional patent application Serial No. 63/792,492 filed Apr. 22, 2025. The aforementioned related patent applications are herein incorporated by reference in their entirety.

### TECHNICAL FIELD

Embodiments presented in this disclosure generally relate to wireless networks. More specifically, embodiments disclosed herein relate to signaling critical updates in ultra-high reliability (UHR) networks.

### BACKGROUND

The Institute of Electrical and Electronics Engineers (IEEE) 802.11bn amendments define a number of features aimed at improving the reliability of communications within a wireless network to establish an ultra-high reliability (UHR) network. An access point (AP) implementing a Basic Service Set (BSS) with UHR features may update normal parameters of the BSS but may also update one or more “critical” parameters that wireless stations (STAs) within the BSS may need to urgently receive and incorporate into their operations.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example environment for signaling UHR critical update information, according to some embodiments of the present disclosure.

FIG. 2 depicts an example format for signaling UHR critical update information in a reduced neighbor report, according to some embodiments of the present disclosure.

FIG. 3A depicts an example format for signaling UHR critical update information in a Basic multi-link element, according to some embodiments of the present disclosure. FIG. 3B depicts an example format 350 for signaling UHR critical update information in a multi-link element, according to some embodiments of the present disclosure.

FIG. 4 is a flow diagram depicting an example method for stations to receive and utilize UHR critical update information, according to some embodiments of the present disclosure.

FIG. 5 is a flow diagram depicting an example method for identifying information to include in a UHR critical update transmission, according to some embodiments of the present disclosure.

FIG. 6 is a flow diagram depicting an example method for identifying information to include in a UHR critical update transmission for an AP multi-link device (MLD), according to some embodiments of the present disclosure.

FIG. 7 is a flow diagram depicting an example method for signaling UHR critical update information, according to some embodiments of the present disclosure.

FIG. 8 depicts an example computing device configured to perform various embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### OVERVIEW

One embodiment presented in this disclosure is directed to a method comprising: implementing, at an affiliated access point (AP) of an AP multi-link device (MLD), an ultra-high reliability (UHR) Basic Service Set (BSS) for one or more non-AP MLDs; receiving an indication of a critical update to a UHR mode of operation or UHR BSS parameters, the critical update affecting the affiliated AP; responsive to the indication: setting a value of a UHR critical update flag to announce a critical update; incrementing a UHR BSS Parameters Change Count (BPCC) value corresponding to the affiliated AP; encoding one or more management frames to include the UHR critical update flag and a basic multi-link element including a UHR critical update information field, the UHR critical update information field comprising the BPCC value and a generation update type value; and transmitting, by the affiliated AP, the one or more encoded management frames.

Other embodiments provide an access point comprising one or more memories and one or more processors communicatively coupled to the one or more memories, wherein the one or more processors are configured to, individually or collectively, perform the aforementioned method, as well as those described herein; and a non-transitory computer readable storage medium comprising instructions that when executed configure one or more processors of an access point to perform the aforementioned methods as well as those described herein.

### EXAMPLE EMBODIMENTS

In some embodiments of the present disclosure, techniques are provided to identify UHR critical update information in an Extended Service Set (ESS) featuring one or more UHR-enabled APs.

In ultra-high reliability networks, updates to critical BSS parameters (e.g., updates to UHR operation modes, other UHR BSS parameters, BSS bandwidth, BSS primary channel, other BSS parameters, etc.), are relayed to wireless stations. After an update is transmitted (e.g., broadcasted, such as in a beacon frame), each wireless station of the AP may receive and parse the updated information.

However, not every station connected to (e.g., associated with) a UHR-enabled AP may be UHR-enabled itself. Accordingly, when signaling updates to critical UHR BSS parameters, an AP may differentiate between pre-UHR BSS parameters updates and UHR BSS parameters updates, so that pre-UHR enabled stations do not parse the entirety of a frame including the UHR critical update information and, consequently, may save power. The critical UHR BSS parameters updates may include updates to UHR mode of operation (e.g. updates to modes such as Dynamic Bandwidth Expansion (DBE), Non-Primary Channel Access (NPCA), Prioritized Enhanced Distributed Channel Access (P-EDCA), Dynamic Sub-band Operation (DSO), and the like), updates to other UHR BSS parameters, updates to UHR MLD level parameters or even updates to some pre-UHR BSS parameters that get communicated to STAs using UHR critical update mechanism.

Embodiments of the present disclosure provide methods, systems, and apparatuses for providing UHR critical update information for a UHR-enabled AP. Moreover, some embodiments are directed towards techniques enabling a network device (e.g., an AP) to identify changes and/or updates to critical UHR parameters within a link of the AP, and transmit the information to wireless STAs associated with the AP. The UHR critical update information may include various indicator and flags, such as a UHR critical update flag (UHR CUF) indicator or generation update type indicator, or a UHR BSS Parameters Change Count (UHR BPCC) indicator. The various indicators discussed herein enable STAs, such as those operating in a low-power or power-saving mode, to wake up and analyze a frame to determine if the critical update information applies to the STA. Accordingly, when a STA determines that critical update information does not apply, the STA can refrain from parsing the remainder of a frame (e.g., and re-enter power-saving or sleep mode), increasing the efficiency of, and decreasing battery consumption of, STAs associated with the AP.

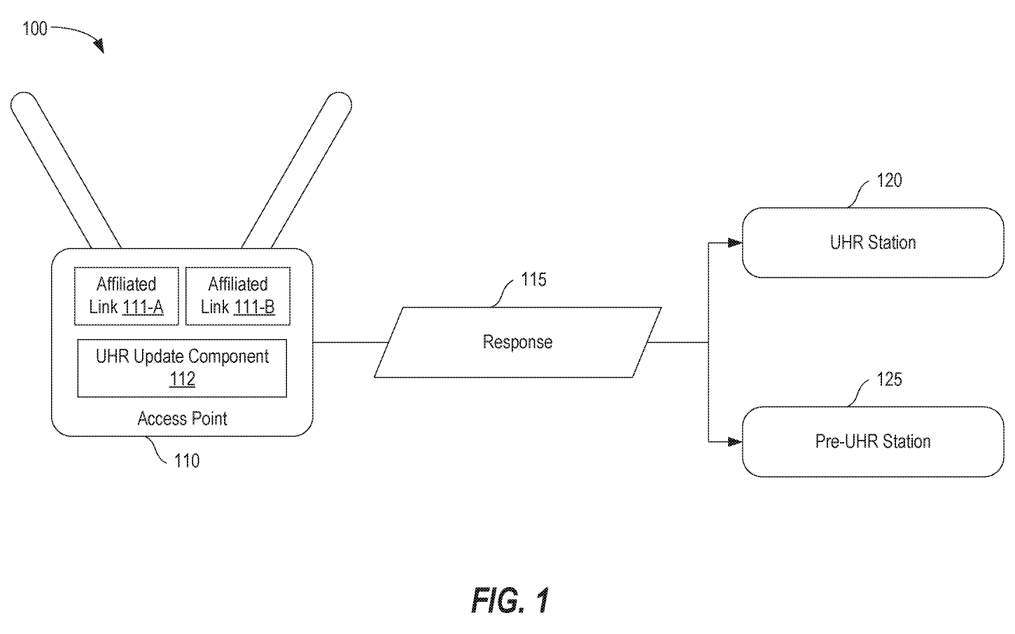

FIG. 1 depicts an example wireless environment 100 in which embodiments of the present disclosure may be implemented. As depicted, the environment 100 includes an AP 110. The AP 110 may generally correspond to an access point used to facilitate or provide connectivity in a wireless network (e.g., a wireless local area network (WLAN), that uses Wi-Fi protocols) and implement one or more BSSs. The AP 110 may be an AP Multi-Link Device (MLD) consisting of one or more affiliated links (e.g., APs), including the affiliated link 111-A and the affiliated link 111-B (collectively, affiliated links 111). Each of the affiliated links 111 may implement a BSS. Accordingly, the one or more BSSs implemented by the AP 110 may be used by wireless STAs, such as a UHR STA 120 and a pre-UHR STA 125 (e.g., an Extremely High Throughput (EHT) or High Efficiency (HE) STA), to connect to and send data throughout a corresponding BSS. The UHR STA 120 and a pre-UHR STA 125 may be STA MLDs (also referred to as non-AP MLD) devices and may include one or more affiliated non-AP STAs which connect to affiliated APs of the AP MLD device

The AP 110 may provide wireless access to one or more wireless STAs (e.g., client devices), such as the UHR STA 120 and the pre-UHR STA 125, discussed above. Each of the UHR STA 120 and the pre-UHR STA 125 may generally be representative of any computing device capable of wireless communications using the WLAN, such as a smartphone, tablet, laptop, wearable computing device (e.g., smartwatch), and the like. In some examples, the UHR STA 120 and/or the pre-UHR STA 125 operate in one or more power-saving modes, such that the STA(s) wake up (e.g., periodically, such as on a pre-determined schedule) to receive information from the AP 110.

The UHR STA 120 may be a STA that is UHR-capable or UHR-enabled, such that the UHR STA 120 is capable of using UHR features or otherwise operating according to UHR standards (e.g., as defined by the 802.11 UHR amendments). Conversely, the pre-UHR STA 125 may be a STA that is not UHR-capable, such that the pre-UHR STA 125 is not capable of using UHR features (e.g., does not support a Wi-Fi generation supporting UHR techniques). In some examples, the capabilities of the UHR STA 120 and the pre-UHR STA 125 are determined based on the Wi-Fi generation that is supported by each respective STA. That is, the UHR STA 120 may be capable of operating a Wi-Fi generation capable of operating according to UHR standards, such as Wi-Fi Generation 8 or later, while the pre-UHR STA 125 may only be capable of operating a Wi-Fi generation that is prior to UHR standards or Wi-Fi generation 8, such as Wi-Fi 7 or earlier. Accordingly, the pre-UHR STA 125 may not desire or be capable of using UHR critical update information that the UHR STA 120 does.

Although depicted in the example environment 100 as only being associated with two STAs (e.g., the UHR STA 120 and the pre-UHR STA 125), the AP 110 may be associated with any number of STAs for active wireless data communications. As depicted in the example environment 100, the AP 110 is concurrently connected to any number of client devices. In some examples, the AP 110 is an AP multi-link device (MLD), such that the AP 110 may operate across multiple bands concurrently using multiple affiliated APs 111, as discussed above. That is, the AP 110 operates (e.g., includes) a plurality of affiliated APs (e.g., links), such that each AP of the plurality of APs manages operations of a particular band of the AP 110. Accordingly, as used herein, an affiliated AP or link may refer to hardware, software, or a combination therein, used to manage and operate a particular band of the AP 110. For example, wherein the AP 110 operates simultaneously across a multitude of frequency bands (e.g., the 2.4 GHz, 5 GHz, and 6 GHz bands), a different affiliated link 111 of the AP 110 may operate each frequency band of the multitude of frequency bands of the AP 110. Although described hereinafter as an AP MLD, in some embodiments, the AP 110 can operate as a single-link AP. Accordingly, each of the UHR STA 120 or the pre-UHR STA 125 can operate as a single-link STA (or a STA non-MLD) or as a STA MLD.

As described herein, the AP 110 may be a UHR-enabled AP, or UHR-capable AP, such that the AP is, or is capable of, implementing UHR features. As discussed above, the AP 110 may change one or more UHR parameters, such as a UHR operation mode or another UHR BSS parameter, that are deemed critical to the operation of the BSS. In some examples, updates are made at the MLD level, such that the UHR update impacts each link of the AP 110. For example, where the AP 110 operates a 2.4 GHz link and a 5 GHz link, the update may impact both the 2.4 GHz and the 5 GHz links. In other examples, updates occur at the link level, such that a UHR update affects only the operations of a single link or AP of the AP 110 (e.g., a 2.4 GHz link).

To provide STAs with information on the UHR parameters critical updates (e.g., critical updates to a UHR mode of operation or another UHR BSS parameter), the AP 110 may encode one or more frames (e.g., wireless management frames, such as a beacon frame, a probe response frame, a (re)association response frame, or a link reconfiguration response frame) where the frame includes information related to a UHR parameters critical update status of the AP 110. The AP 110 may transmit (e.g., broadcast) the frame (e.g., a beacon frame) to the UHR STA 120 and the pre-UHR STA 125 as, or as part of, the response 115. In some examples, the response 115 is transmitted by the AP 110 in response to determining that a UHR parameters critical update has occurred. For example, the AP may send an unsolicited probe response frame when such an update occurs. In other examples, the response 115 is transmitted as a part of one or more scheduled events of the AP 110 (e.g., a broadcast beacon frame intended to be transmitted by the AP 110 on a pre-determined schedule). In some examples, the response 115 is sent by the AP 110 in response to receiving a request from the UHR STA 120 such as a (re)association request frame or a probe request frame. For example, the UHR critical update information is provided by the AP 110 in the (re)association response frame or a probe response frame respectively.

A UHR update component 112 of the AP 110 may determine UHR critical update information to include in the frame(s) of the response 115. To signal UHR critical update information, the UHR update component 112 may determine a UHR BSS Parameter Change Count (BPCC) that represents a change count corresponding to UHR parameters critical updates for a specific AP or an affiliated AP of an AP MLD. The UHR BPCC may be incremented for each UHR parameters critical update that occurs for the corresponding affiliated link 111 of the AP 110. For example, in a frame transmitted at a previous time, a UHR BPCC value may be 10. In response to a single UHR update (or multiple simultaneous UHR critical updates) occurring for an affiliated AP of the AP MLD, the UHR update component 112, or another component of the AP 110, may update the UHR BPCC by incrementing the UHR BPCC by one (e.g., to a value of 11). The UHR BPCC may then be included in the frame, to indicate to the UHR STA 120 that a UHR update has occurred. As described below in greater detail, the UHR BPCC may be included in the frame in an element, such as a Reduced Neighbor Report (RNR) or a Basic Multi-Link (ML) element.

In some embodiments, the response 115 includes additional UHR critical update information. For instance, in some examples, the UHR update component 112 determines a UHR critical update flag (UHR CUF). That is, the UHR update component 112 may determine a value for a UHR CUF field, such that the field may indicate whether the frame includes information for (e.g., announcing) one or more ongoing UHR critical updates (e.g., by setting the UHR CUF to a value of 1) or not (e.g., by setting the UHR CUF to a value of 0). For example, when the UHR update component 112 determines that no ongoing announcements for UHR critical updates are occurring, the UHR CUF may indicate a value of 0.

In some examples, the UHR update component 112 also includes information detailing the parameters and values of each of the UHR critical updates in the response 115. That is, the UHR update component 112 may include, in the response 115, information that a STA may use to determine or otherwise acquire the latest or updated UHR critical update parameters and/or values. In such examples, the UHR update component 112 includes, in the response 115, a UHR All Updates Included (UHR AUI) field, where the value of the UHR AUI update field indicates whether the response 115 includes the UHR parameters updated values (e.g., for UHR parameters updates that resulted in the last increment to the UHR BPCC), or whether a STA should otherwise query the AP 110 (e.g., using a probe request) to obtain the UHR parameters updated values. For example, when the response 115 includes the UHR parameters update values, the UHR AUI field may indicate a value of 1, while in another example, such as when the response 115 does not include UHR parameters updated values, the UHR AUI field may indicate a value of 0.

As described above, in one embodiment a pre-UHR STA (e.g., the pre-UHR STA 125) receives only the information necessary for its operations, such that the pre-UHR STA does not use additional power analyzing UHR critical update information that the STA should not, and, in some examples, cannot utilize. Accordingly, the UHR update component 112 may further determine a value for a generation update type field used to indicate to a STA whether or not the updates apply to the STA or not. That is, the response 115 may include a critical update type value or generation update type field that may indicate an update relevant to a wireless standard generation. The generation update type value may be analyzed by a STA to determine whether the STA should parse the entirety of the response 115 to determine the UHR critical updates (and any associated values). For example, the generation update type field may indicate a value of 1 that indicates that the update applies to UHR of Wi-Fi 8 generation, indicating that only STAs operating at, or, in some examples, above, Wi-Fi generation 8 should parse the response 115.

Accordingly, upon receiving the response 115, the UHR STA 120 may read the generation update type field and determine that it should further analyze the response 115, while the pre-UHR STA 125 does not understand or parse this generation update type field. In some examples, the generation update type field can be extended to indicate applicability of critical updates for other future generations, such as Wi-Fi 9 generation. Accordingly, future 802.11 updates may use the generation update type field to indicate whether a critical update is applicable for Wi-Fi 9 generation, such that the UHR STA 120 and the pre-UHR STA 125 may not need to parse the entire response 115 and can save power by returning to the sleep state after determining that the critical updates indicated in response 115 does not apply for the UHR generation.

In some examples, regardless of the generation update type field value, the UHR STA 120 updates an internal value reflective of the UHR BPCC value. That is, regardless of a generation of the critical updates, the UHR STA (e.g., and future generation STAs, such as a Wi-Fi 9 STA), may update an internal UHR BPCC value in response to determining that a UHR critical update (e.g., either a UHR critical update or a future generation critical update) is available (e.g., based on an internal BPCC value differing from the BPCC value included in the response 115, based on a UHR CUF value indicating the response 115 includes UHR parameters critical update status information, and the like). Accordingly, the UHR BPCC field may be used to signal UHR critical updates and, in future updates, may be used to signal updates to critical parameters for future Wi-Fi generations such as Wi-Fi 9 generation.

In some examples, such as where the AP 110 transmits frames including UHR critical update information on a pre-determined schedule or basis, one or more fields determined by the UHR update component 112 and included in the response 115 may be based on the schedule of the AP 110. That is, any of the fields described above for signaling UHR critical update information may be set long enough to ensure that STAs operating in various sleep or power-saving states can wake up and determine UHR critical update information as desired. For example, where the UHR update component 112 determines a UHR CUF field, the UHR CUF field may remain set in multiple response frames (e.g., such as multiple beacon frames) transmitted subsequent to the response 115 (e.g., until the next transmission of a response including a Delivery Traffic Indication Message (DTIM) beacon). As another example, the UHR CUF may remain set for an advance notification duration defined for the UHR critical updates in the subsequent response frames (e.g., beacon frames).

In some examples, the response 115 includes UHR critical update information for a single affiliated AP (e.g., link) of the AP 110 (e.g., a reporting link of the AP 110). In other examples, the response 115 includes UHR critical update information for multiple affiliated APs (e.g., links) of the AP 110, or any affiliated links 111 of the AP 110. In some examples, the UHR critical update information is included in a reduced neighbor report (RNR) element for one or more affiliated links 111 of the AP device 110 that are reported in the RNR element. In some examples, the UHR critical update information is included in a Multi-Link (ML) element, such as a Basic ML element, to provide information for the reporting AP (e.g., link) of the AP 110 and other affiliated links 111 of the AP 110.

Additionally, in some examples, the AP 110 reports information for a different AP device (not depicted), such as a neighboring AP in the same ESS as the AP 110. For example, the UHR update component 112 may determine UHR critical update information for a neighboring AP to the AP 110 (e.g., by communicating with the neighboring AP, by communication with a wireless Local Area Network (LAN) controller (WLC), etc.), and may provide that information to a STA (e.g., the UHR STA 120) as part of a probing procedure for the neighboring AP via the current AP. For example, this can be provided as part of a Basic ML element that provides information for the neighboring AP in a Neighbor AP Probe Response frame.

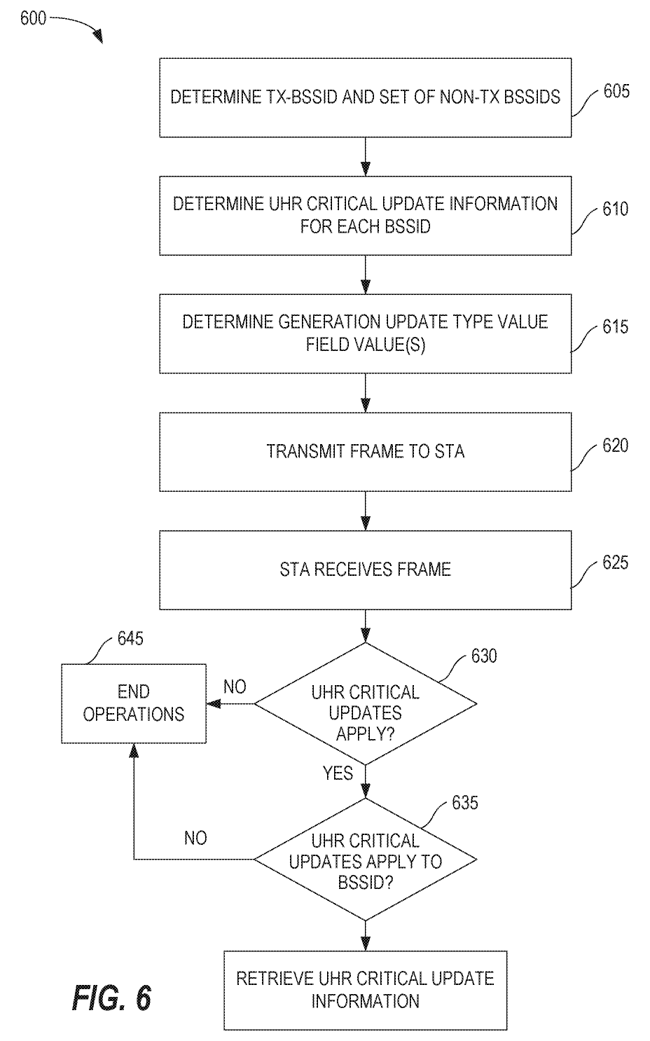

In some examples, the response 115 includes information for multiple BSSID sets operating at the AP 110. That is, in some examples, an affiliated link 111 of the AP 110 includes multiple BSSIDs that are operating on the same band, such that the affiliated link 111 operates a plurality of virtual networks, each of which uses different SSIDs and different BSSIDs. For example, an affiliated link 111-A (e.g., a 5 GHz band) may manage multiple virtual BSSs, each with a unique BSSID for the link, such as broadcasting a “guest” network and a separate “employee” network, each of which has a different BSSID. In said example, each of the virtual BSSs that operate on the affiliated link 111-A may be classified as part of a multiple BSSID set. In such examples, the multiple BSSID set includes one transmission BSSID (TX-BSSID) and one or more non-transmission BSSIDs (non-TX BSSIDs), where the TX-BSSID is used to transmit or broadcast information for each of the BSSs of the multiple BSSID set, including the BSS associated with the TX-BSSID and each BSS associated with the non-TX BSSIDs. For instance, in the previous examples, a BSSID associated with the employee network may be a TX-BSSID used to broadcast beacons that provide information associated with both the employee and the guest networks (e.g., where the guest network is a non-TX BSSID). Accordingly, in such examples, the response 115 includes UHR critical update information associated with each BSSID of the multiple BSSID set of the corresponding affiliated link of the AP 110, as described in greater detail below with respect to FIG. 6. As described herein, each of the BSSIDs of a single multiple BSSID set may, together, form an “AP” of the AP 110. For example, where a TX-BSSID operates on a 2.4 GHz link (e.g., the affiliated link 111-A) and a 5 GHz link (e.g., the affiliated link 111-B), the BSSIDs together may form an AP MLD of the AP 110.

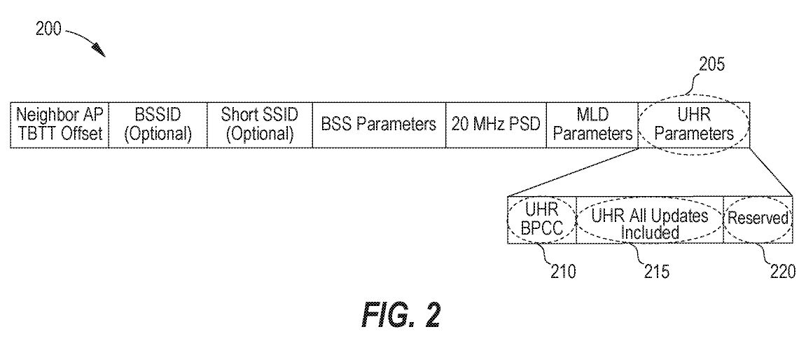

FIG. 2 depicts an example format 200 for signaling UHR critical update information in a reduced neighbor report, according to some embodiments of the present disclosure.

As depicted, an example format 200 illustrates signaling of a reduced neighbor report (RNR). More specifically, the example format 200 illustrates signaling of a Target Beacon Transmission Time (TBTT) Information field in an RNR. In the example format 200, a UHR Parameters field 205 may be included in the TBTT information field on the RNR. The UHR Parameters field 205 may indicate UHR critical update information for an AP, such as the AP 110 of FIG. 1. The UHR Parameters field 205 may include various sub-fields, such as a UHR BPCC field 210, a UHR All Updates Included field 215, and a Reserved field 220.

As discussed with respect to FIG. 1, the UHR BPCC field 210 may represent, or include information representing, a UHR BPCC determined by the UHR update component 112 of the AP 110. The UHR BPCC may indicate change count for UHR critical updates that have occurred, such that the UHR BPCC is incremented each time a UHR critical update occurs. The UHR All Updates Included (UHR AUI) field 215 may represent, or include information representing, a UHR AUI value determined by the UHR update component 112 of the AP 110, where the UHR AUI value may indicate whether a frame (e.g., the beacon frame), or a component of a response including the frame, includes UHR parameters updated values related to the UHR critical updates that have occurred with respect to a previous time (e.g., the UHR parameters critical updates that were responsible for the last increment to the UHR BPCC value carried in the current frame). The Reserved field 220 may be reserved for additional UHR information, such as a UHR CUF field or generation update type field. As depicted in the example format 200, the format may include additional fields, such as fields detailing information on MLD parameters, BSS parameters, and the like.

In the example format 200, any of the fields referenced may be one or more bits in length. In some examples, the RNR element includes separate TBTT Information field for each affiliated link of an AP (e.g., the affiliated links 111 of the AP 110 of FIG. 1) and/or multiple BSSIDs of one or more multiple BSSID set that are hosted at an AP (e.g., the AP 110 of FIG. 1) or other co-located APs on the AP (such as APs is a co-hosted AP set). Accordingly, in some examples, multiple TBTT Information fields are included in the RNR element and each such field provides UHR parameters (including UHR BPCC and UHR AUI field) for an AP that is reported in that TBTT Information field.

In one embodiment of the example format 200, the UHR Parameters field 205 may be one octet in length. In such embodiment, the UHR BPCC field 210 may be defined as a length of any of 4, 5, 6, or 7 bits, while the UHR All Updates Include field 215 may be a single bit. In such embodiment, bits not used by the UHR BPCC field 210 may be reserved for Reserved field 220. In such embodiment, in some examples, the single bit reserved for the UHR All Updates Included field 215 is taken from the MLD parameters field, as opposed to the UHR Parameters field 205, as depicted in the example format 200.

In another embodiment of the example format 200, the UHR Parameters field 205 may be two octets in length. In such embodiment, the UHR BPCC field 210 may be a length of 8 bits, while the UHR All Updates Include field 215 may be a single bit. In such embodiment, any remaining bits may be reserved for Reserved field 220, or other information that an AP wishes to indicate in the example format 200.

Additionally, different types of information may be indicated using different encoding mechanisms. For example, a single bit may be used to distinguish between frames including UHR critical updates and frames not including UHR critical updates (e.g., as indicated by a UHR CUF field, discussed above). However, other encodings, including reserved or extensible values, may also be used.

An AP (e.g., the AP 110 of FIG. 1), may signal the UHR critical update information using the fields illustrated in FIG. 2 (e.g., for one or more reported APs in the RNR element). Such signaling may be included in one or more management frames, such as a beacon frame, a probe response frame, a (re)association frame, or other broadcast or unicast management frames.

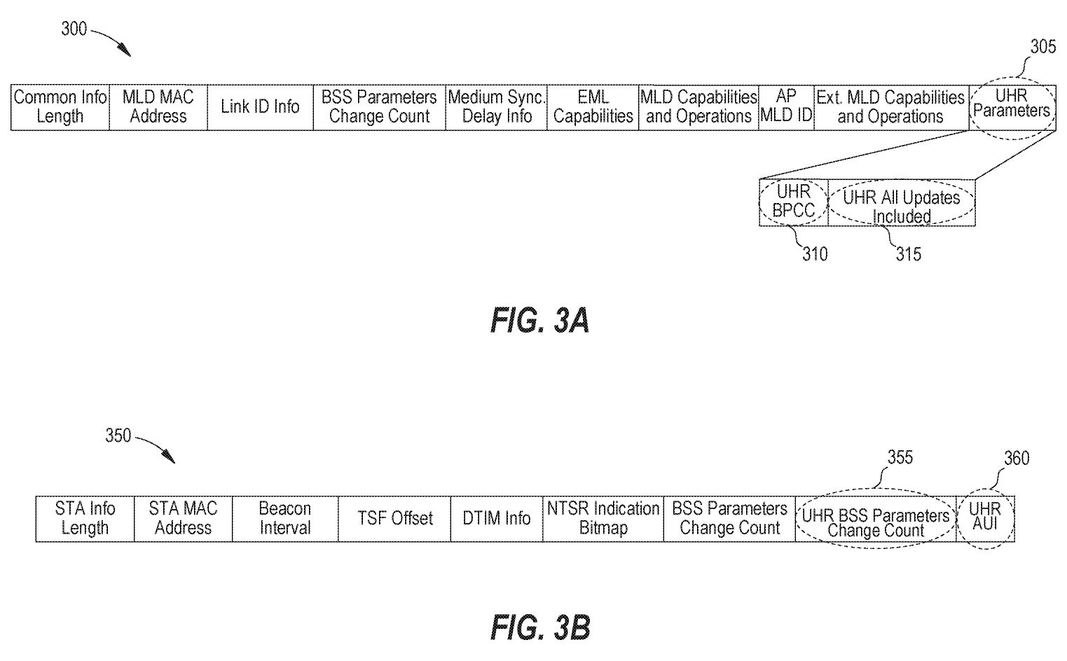

FIG. 3A depicts an example format 300 for signaling UHR critical update information in a Basic multi-link element, according to some embodiments of the present disclosure.

As depicted, an example format 300 illustrates signaling of a Multi-Link (ML) element. More specifically, the example format 300 illustrates signaling of a Common Info field in a Basic ML element. In the example format 300, a UHR Parameters field 305 is included in the Common Info field of the Basic ML element for an AP MLD. The UHR Parameters field 305 may indicate UHR critical update information for an AP, such as the AP 110 of FIG. 1. The UHR Parameters field 305 may include various sub-fields, such as a UHR BPCC field 310 and a UHR AUI field 315.

As discussed with respect to FIG. 1, the UHR BPCC field 310 may represent, or include information representing, a UHR BPCC determined by the UHR update component 112 of the AP 110. The UHR BPCC may indicate a UHR BPCC, as discussed above, for the reporting AP of the AP 110 (which is transmitting the frame carrying the Basic ML element). The UHR All Updates Included (UHR AUI) field 315 may represent, or include information representing, a UHR AUI value, discussed above, signaling whether updated UHR critical parameters values are included in the frame carrying the Basic ML element. In some examples, the presence of UHR Parameters field (or presence of UHR BPCC and/or UHR AUI fields) in the Common Info field of the Basic ML element is indicated by a present bit in the Presence Bitmap field of the Basic ML element.

Although not depicted in the example format 300, in some examples, the example format 300 includes a presence bitmap subfield of a common info field. In such examples, the presence bitmap subfield includes a presence bit or presence flag indicating the presence of UHR critical update information in the common info field.

FIG. 3B depicts an example format 350 for signaling UHR critical update information in a multi-link element, according to some embodiments of the present disclosure.

As depicted, an example format 300 illustrates signaling of a Multi-Link (ML) element. More specifically, the example format 300 illustrates signaling of a STA Info field of a per-STA profile sub-element in a Basic ML element. In the example format 350, a UHR BSS Parameters Change Count field 355 may be included. The UHR BSS Parameters Change Count field 305 may indicate a UHR BPCC for a link (e.g., an affiliated link or affiliated AP) of an AP (e.g., an AP MLD) that is reported in the per-STA profile (e.g., identified by the Link ID in the STA Control field of the per-STA profile), such as any of the affiliated links 111 of the AP 110 of FIG. 1. Additionally, in the example format 350, a UHR AUI field 360 may be included which indicates UHR AUI for the affiliated AP (as described above).

As discussed with respect to FIG. 1, the UHR BSS Parameters Change Count field 355 may represent, or include information representing, a UHR BPCC determined by the UHR update component 112 of the AP 110. The UHR BPCC may indicate a change count for UHR critical updates that have occurred for an affiliated AP or link, such that the UHR BPCC is incremented each time a UHR update occurs for the corresponding affiliated link. The UHR All Updates Included (UHR AUI) field 360 may represent, or include information representing, a UHR AUI value, discussed above, signaling whether updated UHR critical parameters values are included in the frame carrying the Basic ML element. As depicted in the example format 350, the format may include additional fields, such as fields detailing information on a Beacon Interval, STA MAC address, and the like.

In some embodiments, where the example format 350 is utilized, a present field (not depicted) can be included in the STA Control field of the per-STA profile sub-element of the Basic ML element to indicate the presence of the UHR BSS Parameters Change Count field 355 and/or the UHR AUI field 360 in the STA Info (e.g. a UHR BPCC Present field or another present field). Additionally, in some embodiments, where the example format 300 is utilized, the UHR BSS Parameters Change Count field 305 can only be included in transmissions to UHR STAs (e.g., the UHR STA 120 of FIG. 1), and not sent to pre-UHR STAs (e.g., the pre-UHR STA 125 of FIG. 1).

With reference to both the example format 300 of FIG. 3A and the example format 350 of FIG. 3B, any of the fields referenced may be one or more bits in length. Additionally, different types of information by be indicated using different encoding mechanisms. An AP (e.g., the AP 110 of FIG. 1), may signal the UHR critical update information using the fields illustrated in FIGS. 3A and/or 3B. Such signaling may be included in one or more management frames, such as an association response frame, a (re)association response frame, a probe response frame, a Link Reconfiguration response frame, a beacon frame, or other broadcast or unicast management frames that can carry a Basic ML element.

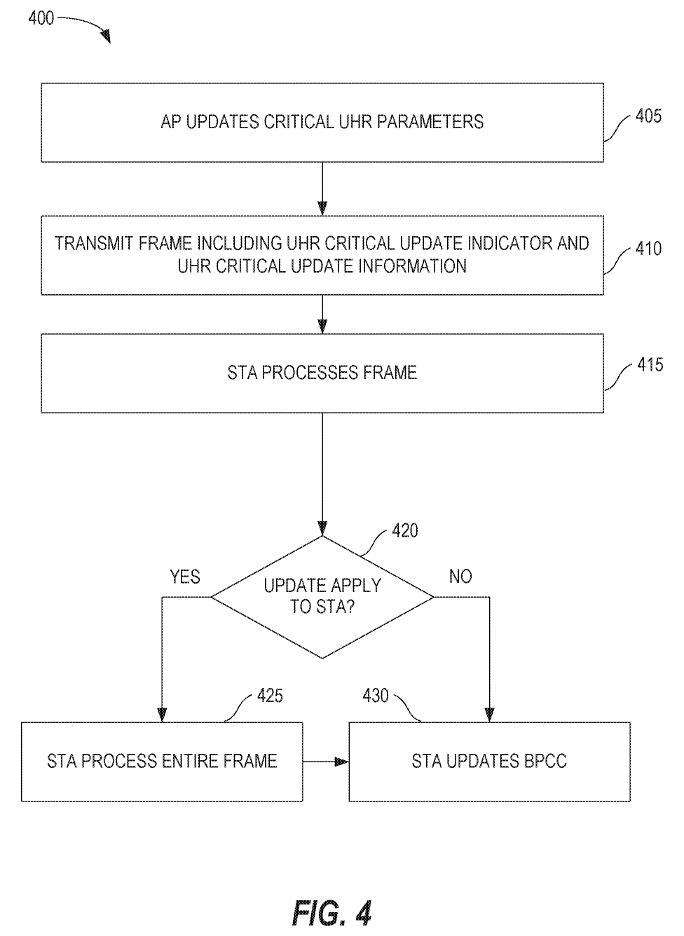

FIG. 4 is a flow diagram depicting an example method 400 for stations to receive and utilize UHR critical update information, according to some embodiments of the present disclosure. The example method 400 may be performed by an AP, such as the AP 110 of FIG. 1.

At block 405, an AP (e.g., the AP 110 of FIG. 1) updates one or more critical UHR parameters or UHR mode of operation. In some examples, such as where the AP is an AP MLD, the update(s) occur at the MLD level of the AP, such that the update affects each affiliated AP (e.g., link) of the AP MLD. In some examples, the update(s) occur at the AP level, such that the update(s) affect only a single affiliated AP (e.g., link) of the AP. In such examples, the AP device can be an AP MLD or a non-MLD AP.

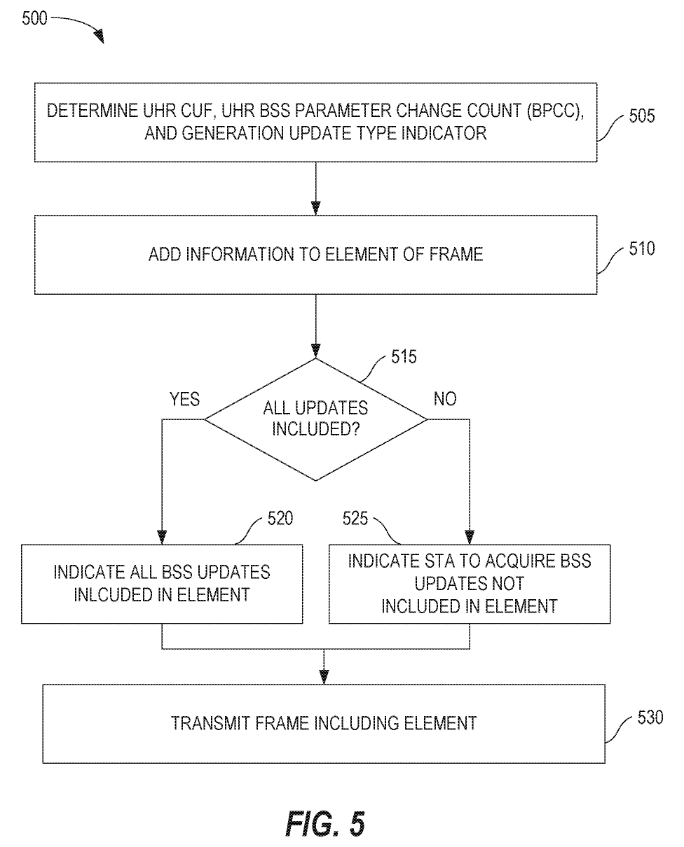

At block 410, in response to receiving an indication of a critical update to UHR parameters or UHR mode of operation, the AP transmits a frame to one or more wireless STAs associated with the AP, where the frame includes a UHR critical update indicator (e.g., a UHR CUF) and UHR critical update information. As disused above, with respect to FIG. 1, the UHR critical update information may be determined by one or more components of the AP (e.g., the UHR update component 112 of AP 110 of FIG. 1), and may include information such as a UHR BPCC, generation update type value (e.g., a generation indicator), where the generation update type value is used to indicate what generation of STAs the updates apply to, based on the Wi-Fi generation supported by the STA (e.g., an update relevant to a specific wireless standard generation or set of wireless standard generations), a UHR AUI indicator, and the like. Additional details regarding the determination of the UHR critical update information, and the creation of the frame, are described below, with respect to FIG. 5.

At block 415, a wireless STA (e.g., the UHR STA 120 of FIG. 1) receives the frame and begins processing (e.g., analyzing) the frame. At block 420, the STA determines whether the UHR critical update information applies to the STA. To determine whether the UHR critical update information applies to the STA, the STA may analyze the generation update type indicator included in the frame. For example, where a generation update type indicator in the frame indicates Wi-Fi 8 generation, a STA may only determine that the update applies to the STA if the STA supports Wi-Fi 8 generation or higher. In such an example, with respect to FIG. 1, the UHR STA 120 may determine that the updates apply to the STA. In future where a generation update type may indicate a Wi-Fi 9 generation update, those updates may not apply to UHR STAs. If the STA determines that updates do not apply to the STA, the STA proceeds according to the “NO” branch to block 430, discussed below.

If the STA determines that updates apply to the STA based on the generation update type, the STA proceeds according to the “YES” branch to block 425. At block 425, the STA processes the entirety of the frame. In examples where the frame includes a UHR AUI field, the STA may determine, based on the UHR AUI field, whether the frame includes the updated UHR values for the relevant UHR critical updates to the AP. If the frame does include the updated UHR values (e.g., where the UHR AUI field indicates a value of 1), the STA may process the frame to retrieve the updated UHR parameters. If the frame does not include the updated UHR values (e.g., where the UHR AUI field indicates a value of 0), the STA may retrieve the updated parameters through additional communications with the AP. For example, the STA may transmit a probe request to the AP to obtain the updated values and parameters. In some examples, this probe request, and/or a subsequent probe response from the AP, are transmitted as a protected management frame (PMF). At block 430, a STA, regardless of whether the updates applied to the STA or not, updates an internal UHR BPCC value based on the UHR BPCC value reported by the AP.

FIG. 5 is a flow diagram depicting an example method for identifying information to include in a UHR critical update transmission, according to some embodiments of the present disclosure. The example method 500 may be performed by an AP, such as the AP 110 of FIG. 1. In some examples, the example method 500 provides additional details to the block 410 of FIG. 4.

At block 505, an AP (e.g., the AP 110 of FIG. 1) determines a UHR BPCC value and a generation update type indicator. That is, the AP, or a component therein (e.g., the UHR update component 112 of FIG. 1) determines a UHR BPCC, indicating a change count for UHR parameters updates, and a generation update type indicator indicating the generation for which the updates apply. The AP also determines a UHR CUF value, indicating the presence of a UHR critical updates. In some examples, as discussed above, the AP also determines additional information to include in a frame, such as a UHR AUI field value (described below), and the like.

In some examples, the AP determines UHR critical update information in response to determining that a UHR update has taken place. In other examples, the AP determines UHR information periodically (e.g., based on a pre-determined schedule), such that, in some examples, the AP determines that no UHR critical updates have taken place (e.g., such that a UHR BPCC is the same at the current frame and at the most recently transmitted frame). In other examples, the UHR information is determined in response to receiving a request from a STA (e.g., a (re)association Request, a probe request, etc.).

At block 510, the AP adds (e.g., encodes) the UHR critical update information (e.g., the UHR BPCC and the generation update type indicator) to an element of a frame (e.g., a basic ML element, a reduced neighbor report, etc.). For example, where the frame is a beacon frame, the AP may include the information in an RNR element. For example, the UHR BPCC may be included in the UHR Parameters field 205 (using the UHR BPCC field 210), according to the example format 200 of FIG. 2. As another example, where the frame is an association response, a (re)association Response, or probe response, the AP may include the UHR critical update information in a Basic ML element (e.g., in a Common Info field or a Basic ML element and/or in a STA Info field of a per-STA profile of a Basic ML element). For example, the UHR critical update information may be included in the UHR BSS Parameter Change Count field 310 and/or the UHR AUI field 315, according to the example format 300 of FIG. 3A, or the UHR BPCC field 355 and/or the UHR AUI field 360, according to the example format 350 of FIG. 3B.

At block 515, the AP determines whether or not the frame should include updated values and/or parameters associated with the UHR critical updates. That is, the AP determines whether to include values associated with each of the updates in the frame, or whether a STA should communicate directly with the AP to retrieve the values and parameters. In some examples, this decision is based on a number of factors, such as the number of UHR critical updates, the size of the frame, the number of STAs associated with the AP, the number of UHR STAs associated with the AP, and the like.

If the AP determines that each updated value should be included in the frame, the AP proceeds according to the “YES” branch to block 520. At the block 520, the AP includes each of the UHR updated values and parameters in the frame, such that a STA may parse the frame to retrieve the values. Accordingly, in some examples, the AP includes a UHR AUI field and sets a value for the UHR AUI field (discussed above) to indicate to the STA that the updated UHR values and parameters are included in the frame. For example, the AP may set the UHR AUI field to a value of 1. If the AP determines that each update value should not be included in the frame, the AP proceeds according to the “NO” branch to block 525. At block 525, the AP refrains from including the updated UHR values and parameters in the frame. Accordingly, in some examples, the AP sets a value for the UHR AUI field (e.g., set to a value of 0) to indicate to the STA that updated values and parameters are not included in the frame, such that the STA should communicate with the AP directly (e.g., using a probe request) to retrieve the update parameters.

At block 530, the AP transmits the frame including the element to one or more STAs associated with the AP. As discussed above, in some examples, the frame is a beacon frame, such as a DTIM beacon, such that the AP may broadcast the beacon frame to the one or more STAs. In some examples, the frame is transmitted on a schedule. For example, the beacon frames (e.g., a DTIM beacon, a non-DTIM beacon, etc.) may be scheduled to be transmitted or otherwise broadcasted at pre-set intervals. In such examples, UHR critical update information (e.g., the UHR CUF field) may be set until and including the next DTIM beacon, or may be set longer, to ensure that devices in a low-power or power-saving mode (e.g., a sleeping STA) can receive and analyze the UHR CUF and acquire UHR critical update information. In other examples, the frame is transmitted in response to determining that a UHR update has occurred. In some other examples, the frame is transmitted in response to receiving a request (e.g., a probe request) for UHR critical update information from a STA.

Accordingly, as discussed above, the frame may include an ML element (e.g., a Basic ML element), an RNR, or other element configured to carry the UHR critical update information, such as a UHR Operation element. In some examples, the UHR information could be included in multiple different and/or separate elements and/or fields in a frame. For example, the generation update type indicator may be carried in a UHR Operation element, while the UHR BPCC and UHR AUI are carried in the Basic ML element, in a Prescence Bitmap field of the ML element, and the like.

In some examples, the UHR critical update information determined and transmitted is related to the AP responsible for performing the actions of blocks 505-530. That is, in some examples, the AP determines and transmits UHR critical update information for itself. However, in other examples, the AP determines and transmits UHR critical update information for another affiliated link or AP of an AP MLD in the per-STA profile of the Basic ML element. In some examples, the AP can determine and transmit UHR critical update information for a neighboring AP as part of a probing procedure for the neighboring AP vis the current AP. For example, UHR critical update information may be provided as part of a Basic ML element that provides information for the neighboring AP in a Neighbor AP Probe Response frame.

FIG. 6 is a flow diagram depicting an example method for identifying information to include in a UHR critical update transmission for an AP device (MLD) operating a multiple BSSID set and operating an AP MLD for BSSIDs of the multiple BSSID set, according to some embodiments of the present disclosure. The example method 600 may be performed by an AP, such as the AP 110 of FIG. 1.

At block 605, an AP MLD device (e.g., the AP 110 of FIG. 1) determines a transmission BSSID and a set of non-transmission BSSIDs of a multiple BSSID set. That is, each link or band of the AP MLD (e.g., the affiliated links 111 of the AP 110 of FIG. 1) may operate a multiple BSSID set consisting of multiple BSSIDs, such that a single link or band (e.g., radio hardware unit) of the AP operates multiple virtual networks (e.g., BSSs), each operating at their own BSSID. Each link/band of the AP may transmit information, such as beacons, using a single BSSID of the multiple BSSID set, referred to as a transmission BSSID (TX-BSSID), as discussed above with respect to FIG. 1. Each of the other BSSIDs in the multiple BSSID set are referred to as non-TX BSSIDs and may have their respective information transmitted by the TX-BSSID (e.g., in the beacons).

The AP may determine and transmit UHR critical update information in response to receiving an indication that a critical update (e.g., an update to a UHR operation mode or UHR parameters) has occurred to an AP associated with the any non-TX BSSID in a multiple BSSID set, or any affiliated link associated with the same AP MLD as any of the non-TX BSSIDs of the multiple BSSID set. Accordingly, any UHR critical updates that happen to any of the affiliated APs that belong to the AP of any non-TX BSSID (including the non-TX BSSID itself) may be indicated in a beacon transmitted by the TX-BSSID of the multiple BSSID set.

At block 610, the AP determines UHR critical update information for each applicable BSSID of the multiple BSSID set of the AP. That is, the AP determines any UHR critical updates that have been happen for 1) the TX-BSSID of a multiple BSSID set for any of the links of the AP MLD (e.g., the link at which the TX-BSSID operates), or for any of the affiliated APs that belong to the AP MLD of the TX-BSSID, or 2) a non-TX BSSID of the multiple BSSID set for any of the links of the AP MLD (e.g., the link at which the non-TX BSSID operates), or for any of the affiliated APs of the AP MLD of the non-TX BSSID. As one example, the AP may operate a “Guest” BSSID and an “Employee” BSSID, where each of the BSSIDs operates on a 2.4 GHz link and a 5 GHz link. The TX-BSSID, as determined at block 605, may be the “Employee” BSSID on the 5 GHz link, such that the 5 GHz “Employee” BSSID transmits critical update information for the “Guest” BSSID (which is a non-TX BSSID) on the 5 GHz link, and UHR critical update information for the “Guest” BSSID and an “Employee” BSSID operating on the 2.4 GHz link. As discussed above, Employee BSSID on 5 GHz link and 2.4 GHz link form an AP MLD. Similarly, the Guest BSSID on 5 GHz link and 2.4 GHz link form another AP MLD. The AP may determine UHR critical update information, such as a UHR BPCC, a UHR CUF, or a UHR AUI field for each of the BSSIDs described above for the multiple BSSID set. In some examples, the UHR critical update information is included in a Non-transmitted BSSID profile, such that each Non-transmitted BSSID profile details UHR critical update information for a specific non-TX BSSID operating at a specific link and are included in a multiple BSSID element in the frame.

At block 615, the AP determines a value for at least one generation update type field. Initially, the AP may determine a value for a generation update type field that may represent the generation corresponding to all the updates across all the BSSIDs included in the frame. For example, the generation update type field may be included in the Capability Information field of the frame and may indicate a wireless generation for which critical updates apply. The generation update value may be applicable to any UHR critical updates for the AP corresponding to the TX-BSSID and any affiliated APs of the AP MLD of the TX-BSSID and any UHR critical updates for any of the APs corresponding to any of the non-TX BSSIDs of the multiple BSSID set and any affiliated APs of the AP MLDs of any of the non-TX BSSID. In this way, STAs that are associated with the TX-BSSID, or any of the non-TX BSSIDs, know the generation of updates for their respective associated AP links, such that the STA may then decide if additional processing of the frame (e.g., a beacon) is necessary.

That is, by only indicating generation information for UHR critical updates related to the TX-BSSID, STAs that are associated with any non-TX BSSIDs may not be adequately aware of the generation of UHR update that apply to them, and may continue to parse the frame even if the UHR critical updates would not apply to the STA otherwise, leading to increased energy usage, or a desire for the STA to associate with the TX-BSSID over any of the non-TX BSSIDs. Additionally, the AP may determine a value for a generation update type field for each BSSID profile in the frame, such that the value of the generation update type field is only used by STAs associated with the respective BSSID and link of the BSSID profile. In some examples, separate generation update type fields are used to indicate values for the TX-BSSID and for the set of non-TX BSSIDs, such as the generation update type field for the TX-BSSID being included in a UHR Operation element.

In some examples, the value of the generation update type field is a minimum value of the generations required for each respective UHR update. For example, if a generation value for the TX-BSSID is indicating Wi-Fi 7, and the generation value for a non-TX BSSID is indicating Wi-Fi 8, the value of the generation update type field may be the minimum of the two (e.g., indicating Wi-Fi 7), so that all STAs are updated accordingly, and no STAs are left out of the critical update procedure.

At block 620, the AP transmits the frame to one or more STAs. For example, when the frame is a beacon, the AP may broadcast the beacon to one or more STAs associated with the AP. At block 625, a STA receives the frame including the UHR critical update information. At block 630, the STA determines whether the UHR critical updates apply to the STA. To determine whether the UHR critical update information applies to the STA, the STA may analyze the generation update type indicator included representing all of the critical updates included in the frame. For example, where a value for the generation update type indicator for the total frame indicates Generation 8, a STA may only determine that the update applies if the STA supports Wi-Fi Generation 8 or higher. In some examples, such as where the STA is associated with the TX-BSSID, the STA analyzes a separate TX-BSSID generation update type field, if said field is included in the frame. If the STA determines that updates do not apply, the STA proceeds according to the “NO” branch to block 645, where the STA ends operations (e.g., ends processing of the frame). In some examples, prior to ending operations, the STA updates an internal UHR BPCC, based on one more values in the frame.

If the STA determines that updates apply, the STA proceeds according to the “YES” branch to block 635. At block 635, the STA processes the Non-transmitted BSSID profiles in the multiple BSSID element in the frame to determine whether updates apply for the specific link of the BSSID for which the STA is associated. For example, the STA may analyze the generation update type field included in the BSSID profile corresponding to the BSSID for which the STA is associated with. In some examples, such as where the Non-transmitted BSSID profile includes a UHR CUF, the STA uses the UHR CUF in the determination. If the STA determines that updates have not happened to the link of the BSSID for which the STA is associated, the STA proceeds according to the “NO” branch to block 645.

If the STA determines that updates have happened to the link of the BSSID for which the STA is associated, the STA proceeds according to the “YES” branch to block 640. At block 640, the STA retrieves (e.g., accesses) the UHR BPCC value indicated in the Non-transmitted BSSID profile. The STA may compare the UHR BPCC included in the Non-transmitted BSSID profile with the UHR BPCC value internal to the STA and determine whether UHR update values are desired. That is, the STA may determine whether the UHR update values are included in the frame, or whether the STA may need to query the AP to determine the UHR update values. This process may be further described with respect to blocks 515, 520, and 525 of FIG. 5.

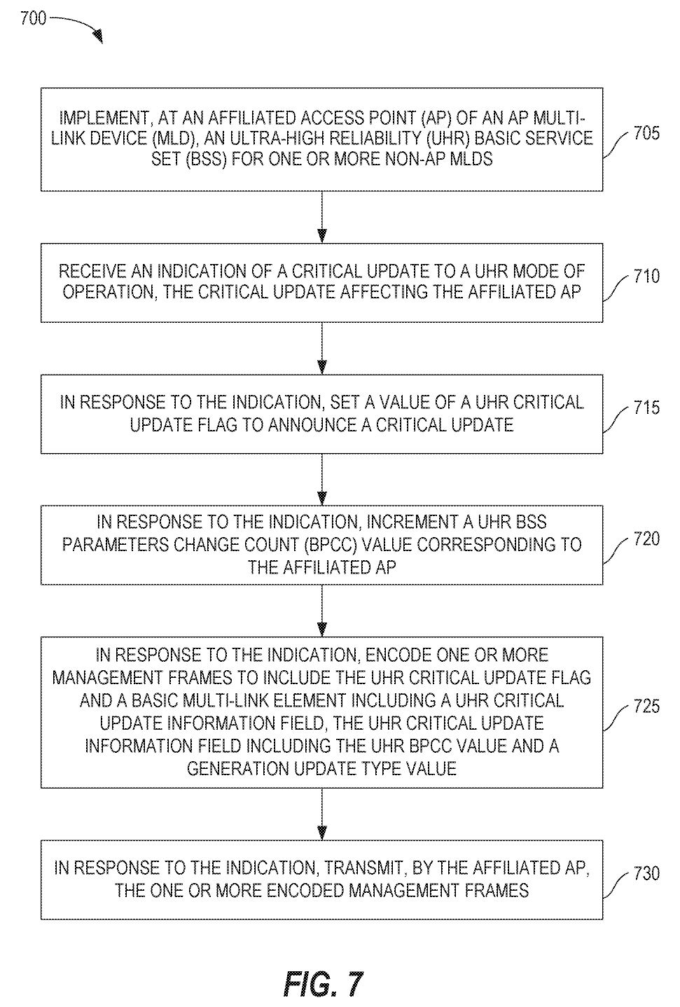

FIG. 7 is a flow diagram depicting an example method for signaling UHR critical update information, according to some embodiments of the present disclosure. The example method 700 may be performed by an AP, such as the AP 110 of FIG. 1.

At block 705, an affiliated AP of an AP MLD (e.g., the AP 110 of FIG. 1) implements a UHR BSS for one or more non-AP MLDs (e.g., the UHR STA 120 and the pre-UHR STA 125 of FIG. 1).

At block 710, an indication of a critical update to a UHR mode of operations is received, where the critical update affects the affiliated AP. In some examples, block 710 may correspond to, or provide additional or alternative details for, the operations discussed above with reference to block 405 of FIG. 4.

At block 715, in response to the receipt of the indication, a value of a UHR CUF is set to announce a critical update. In some examples, block 715 may correspond to, or provide additional or alternative details for, the operations discussed above with reference to block 505 of FIG. 5.

At block 720, in response to the receipt of the indication, a UHR BPCC corresponding to the affiliated AP is incremented. In some examples, block 720 may correspond to, or provide additional or alternative details for, the operations discussed above with reference to block 505 of FIG. 5.

At block 725, in response to the receipt of the indication, one or more management frames are encoded to include the UHR CUF and a basic ML element including a UHR critical update information field, the UHR critical update information field including the UHR BPCC value and a generation update type value. In some examples, block 725 may correspond to, or provide additional or alternative details for, the operations discussed above with reference to block 510 of FIG. 5. In some examples, the basic ML element is formatted according to the example format 300 of FIG. 3.

At block 730, in response to the receipt of the indication, the one or more encoded management frames are transmitted by the affiliated AP. In some examples, block 730 may correspond to, or provide additional or alternative details for, the operations discussed above with reference to block 410 of FIG. 4 or block 530 of FIG. 5.

In some examples, the operations of the example method 700 further include encoding the one or more management frames to include critical update parameters associated with the critical update. In some examples, the operations of the example method 700 further include encoding the one or more management frames to include an indication to signal that all UHR critical update parameters associated with the critical update are included in the one or more management frames. In some examples, said operations may correspond to, or provide additional or alternative details for, the operations discussed above with reference to block 520 of FIG. 5.

In some examples, the generation update type value indicates an update is relevant to a wireless standard generation.

In some examples, the one or more management frames are beacon frames.

In some examples, the one or more management frames are probe response frames, association response frames, or (re)association response frames.

In some examples, the UHR critical update information field is included in a common info field in the basic multi-link element, where the basic multi-link element further includes a presence bitmap subfield, the presence bitmap subfield including a presence bit indicating a presence of the UHR critical update information field in the common info field.

In some examples, the operations of the example method 700 further include receiving, by the affiliated AP, an indication of a critical update to a UHR mode of operation affecting a second affiliated AP of the AP MLD; responsive to the indication of a critical update to a UHR mode of operation affecting a second affiliated AP of the AP MLD: setting the value of the UHR critical update flag to indicate a critical update; incrementing a UHR BSS Parameters Change Count (BPCC) value corresponding to the second affiliated AP; and encoding the one or more management frames to include the UHR critical update flag and a reduced neighbor report element, the reduced neighbor report element including a second UHR critical update information field, the second UHR critical update information field including the UHR BPCC value corresponding to the second affiliated AP and a generation update type value.

In some examples, the operations of the example method 700 further include receiving an indication of a critical update to a UHR mode of operation for a second affiliated AP of the AP MLD; incrementing a UHR BSS Parameters Change Count (BPCC) value corresponding to the second affiliated AP; encoding the one or more management frames to include the UHR critical update flag and a basic multi-link element including a second UHR critical update information field for the second affiliated AP, the UHR critical update information field comprising the UHR BPCC value and a generation update type value; and transmitting, by the affiliated AP, the one or more encoded management frames. In some embodiments, the second UHR critical update information field is included in a STA Info field in a per-STA Profile sub-element of the basic multi-link element, where a STA Control field in the per-STA Profile sub-element in the basic multi-link element further includes a presence bit indicating a presence of the second UHR critical update information field in the STA Info field.

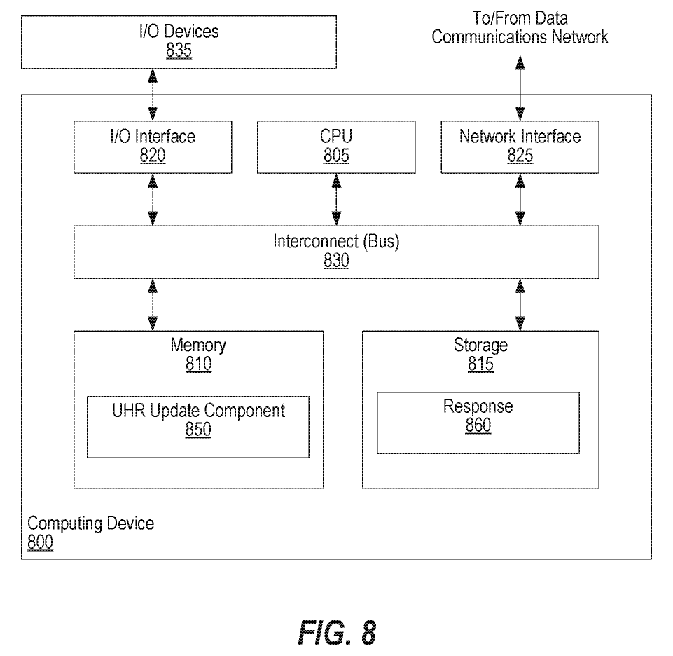

FIG. 8 depicts an example computing device 800 configured to perform various aspects of the present disclosure, according to some embodiments of the present disclosure. Although depicted as a physical device, in embodiments, the computing device 800 may be implemented using any number of virtual or physical device(s) (e.g., in a cloud environment). In one embodiment, the computing device 800 corresponds to or implements a networking device (e.g., an AP), such as the AP 110 of FIG. 1 or the APs discussed above with reference to FIGS. 4-7.

As illustrated, the computing device 800 includes a CPU 805, a memory 810, a storage 815, a network interface 825, and one or more I/O interfaces 820. In the illustrated embodiment, the CPU 805 retrieves and executes programming instructions stored in the memory 810, as well as stores and retrieves application data residing in the memory 810, the storage 815, or both. The CPU 805 is generally representative of a single CPU, a single GPU, multiple CPUs, multiple GPUs, a single CPU having multiple processing cores, a single GPU having multiple processing cores, a microcontroller, an application-specific integrated circuit (ASIC), or a programmable logic device (PLD), and the like.

In some embodiments, the I/O devices 835 (such as keyboards, monitors, etc.) are connected via the I/O interface(s) 820. Further, via the network interface 825, the computing device 800 can be communicatively coupled with one or more other devices and components (e.g., via a network, which may include the Internet, local network(s), and the like). As illustrated, the CPU 805, the memory 810, the network interface(s) 825, and the I/O interface(s) 820 are communicatively coupled by one or more buses 830.

The storage 815 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 815 may store a variety of data for the efficient functioning of the system.

The memory 810 is generally included to be representative of a random-access memory. The memory 810 may store processor-executable software code containing instructions that, when executed by the CPU 805, enable the computing device 800 to perform various functions described herein for wireless communication. The memory 810 may include random access memory (RAM) and read-only memory (ROM).

As depicted, the memory 810 includes a UHR update component 850. Although depicted as a discrete component for conceptual clarity, in embodiments, the operations of the UHR update component 850 (and other components not illustrated) may be combined or distributed across any number of components. Further, although depicted as software residing in the memory 810, in embodiments, the operations of the depicted components (and others not illustrated) may be implemented using hardware, software, or a combination of hardware and software.

The UHR update component 850 may generally correspond, and operate in a similar manner to, the UHR update component 112 of AP 110 of FIG. 1. The UHR update component 850 may determine UHR critical update information associated with an AP. The UHR update component 850 may determine a UHR BPCC that represents the number of UHR critical updates (e.g., changes) at the time of the frame transmission, with respect to a previous frame transmission. That is, the UHR BPCC may be incremented with each UHR update that occurs within the AP 110. In some examples, the UHR update component 850 determines additional information, such as a UHR CUF indicating the presence of UHR update, a UHR AUI indicator indicating whether or not the response 860 (discussed below) includes parameters and values on all UHR critical updates indicated by the response 860, or a generation update type value indicating an update relevant to a wireless standard generation.

The computing device 800 may generate one or more responses, such as the response 860, to STAs (e.g., the UHR STA 120 and/or the pre-UHR STA 125 of FIG. 1), providing the STA with UHR critical update information on the link or AP MLD affected by the UHR critical updates. For example, the computing device 800 may transmit the response 860, such as a wireless management frame (e.g., a beacon frame, a (re)association response frame, a probe response frame, etc.) to the STA. The response 860 may include a reduced neighbor report element or basic ML element, to the STA, including a UHR BPCC (e.g., using the UHR BPCC field 210 of FIG. 2 or the UHR BSS Parameters Change Count field 305 of FIG. 3, respectively), as described above. Although depicted as residing in the storage 815, the response 860 of the computing device 800 may be stored in any suitable location.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
implementing, at an affiliated access point (AP) of an AP multi-link device (MLD), an ultra-high reliability (UHR) Basic Service Set (BSS) for one or more non-AP MLDs;
receiving an indication of a critical update to a UHR mode of operation, the critical update affecting the affiliated AP;
responsive to the indication:
setting a value of a UHR critical update flag to announce a critical update;
incrementing a UHR BSS Parameters Change Count (BPCC) value corresponding to the affiliated AP;
encoding one or more management frames to include the UHR critical update flag and a basic multi-link element including a UHR critical update information field, the UHR critical update information field comprising the UHR BPCC value and a generation update type value; and
transmitting, by the affiliated AP, the one or more encoded management frames.

2. The method of claim 1 further comprising encoding the one or more management frames to include critical update parameters associated with the critical update.

3. The method of claim 2 further comprising encoding the one or more management frames to include an indication to signal that all UHR critical update parameters associated with the critical update are included in the one or more management frames.

4. The method of claim 1 wherein the generation update type value indicates an update is relevant to a wireless standard generation.

5. The method of claim 1 wherein the one or more management frames are beacon frames.

6. The method of claim 1 wherein the one or more management frames are probe response frames, association response frames, or (re)association response frames.

7. The method of claim 1 wherein the UHR critical update information field is included in a common info field in the basic multi-link element and wherein the basic multi-link element further includes a presence bitmap subfield, the presence bitmap subfield comprising a presence bit indicating a presence of the UHR critical update information field in the common info field.

8. The method of claim 1 further comprising:
receiving, by the affiliated AP, an indication of a critical update to a UHR mode of operation affecting a second affiliated AP of the AP MLD;
responsive to the indication of a critical update to a UHR mode of operation affecting a second affiliated AP of the AP MLD:
setting the value of the UHR critical update flag to indicate a critical update;
incrementing a UHR BSS Parameters Change Count (BPCC) value corresponding to the second affiliated AP; and
encoding the one or more management frames to include the UHR critical update flag and a reduced neighbor report element, the reduced neighbor report element including a second UHR critical update information field, the second UHR critical update information field comprising the UHR BPCC value corresponding to the second affiliated AP and a generation update type value.

9. The method of claim 1, further comprising:
receiving an indication of a critical update to a UHR mode of operation for a second affiliated AP of the AP MLD;
incrementing a UHR BSS Parameters Change Count (BPCC) value corresponding to the second affiliated AP;
encoding the one or more management frames to include the UHR critical update flag and a basic multi-link element including a second UHR critical update information field for the second affiliated AP, the UHR critical update information field comprising the UHR BPCC value and a generation update type value; and
transmitting, by the affiliated AP, the one or more encoded management frames.

10. The method of claim 9, wherein the second UHR critical update information field is included in a STA Info field in a per-STA Profile sub-element of the basic multi-link element and wherein a STA Control field in the per-STA Profile sub-element in the basic multi-link element further includes a presence bit indicating a presence of the second UHR critical update information field in the STA Info field.

11. An access point (AP) multi-link device (MLD) comprising:
one or more affiliated APs;
at least one memory element for storing data; and
at least one processor for executing instructions associated with the data, wherein executing the instructions causes the AP MLD to perform operations, comprising:
implementing, at an affiliated AP of the AP MLD, an ultra-high reliability (UHR) Basic Service Set (BSS) for one or more non-AP MLDs;
receiving an indication of a critical update to a UHR mode of operation, the critical update affecting the affiliated AP;
responsive to the indication:
setting a value of a UHR critical update flag to announce a critical update;
incrementing a UHR BSS Parameters Change Count (BPCC) value corresponding to the affiliated AP;
encoding one or more management frames to include the UHR critical update flag and a basic multi-link element including a UHR critical update information field, the UHR critical update information field comprising the UHR BPCC value and a generation update type value; and
transmitting, by the affiliated AP, the one or more encoded management frames.

12. The AP MLD of claim 11, the operations further comprising encoding the one or more management frames to include critical update parameters associated with the critical update.

13. The AP MLD of claim 12, the operations further comprising encoding the one or more management frames to include an indication to signal that all UHR critical update parameters associated with the critical update are included in the one or more management frames.

14. The AP MLD of claim 11 wherein the generation update type value indicates an update is relevant to a wireless standard generation.

15. The AP MLD of claim 11 wherein the one or more management frames are beacon frames.

16. The AP MLD of claim 11 wherein the one or more management frames are probe response frames, association response frames, or (re)association response frames.

17. The AP MLD of claim 11 wherein the UHR critical update information field is included in a common info field in the basic multi-link element and wherein the basic multi-link element further includes a presence bitmap subfield, the presence bitmap subfield comprising a presence bit indicating a presence of the UHR critical update information field in the common info field.

18. The AP MLD of claim 11, the operations further comprising:
receiving, by the affiliated AP, an indication of a critical update to a UHR mode of operation affecting a second affiliated AP of the AP MLD;
responsive to the indication of a critical update to a UHR mode of operation affecting a second affiliated AP of the AP MLD:
setting the value of the UHR critical update flag to indicate a critical update;
incrementing a UHR BSS Parameters Change Count (BPCC) value corresponding to the second affiliated AP; and
encoding the one or more management frames to include the UHR critical update flag and a reduced neighbor report element, the reduced neighbor report element including a second UHR critical update information field, the second UHR critical update information field comprising the UHR BPCC value corresponding to the second affiliated AP and a generation update type value.

19. The AP MLD of claim 11, the operations further comprising:
receiving an indication of a critical update to a UHR mode of operation for a second affiliated AP of the AP MLD;
incrementing a UHR BSS Parameters Change Count (BPCC) value corresponding to the second affiliated AP;
encoding the one or more management frames to include the UHR critical update flag and a basic multi-link element including a second UHR critical update information field for the second affiliated AP, the UHR critical update information field comprising the UHR BPCC value and a generation update type value; and
transmitting, by the affiliated AP, the one or more encoded management frames.

20. The AP MLD of claim 19, wherein the second UHR critical update information field is included in a STA Info field in a per-STA Profile sub-element of the basic multi-link element and wherein a STA Control field in the per-STA Profile sub-element in the basic multi-link element further includes a presence bit indicating a presence of the second UHR critical update information field in the STA Info field.

21. A non-transitory computer readable storage medium comprising instructions that when executed configure one or more processors of an access point (AP) multi-link device (MLD) to perform operations comprising:
implementing, at an affiliated AP of the AP MLD, an ultra-high reliability (UHR) Basic Service Set (BSS) for one or more non-AP MLDs;
receiving an indication of a critical update to a UHR mode of operation, the critical update affecting the affiliated AP;
responsive to the indication:
setting a value of a UHR critical update flag to announce a critical update;
incrementing a UHR BSS Parameters Change Count (BPCC) value corresponding to the affiliated AP;
encoding one or more management frames to include the UHR critical update flag and a basic multi-link element including a UHR critical update information field, the UHR critical update information field comprising the UHR BPCC value and a generation update type value; and
transmitting, by the affiliated AP, the one or more encoded management frames.

22. The non-transitory computer readable storage medium of claim 21, the operations further comprising encoding the one or more management frames to include critical update parameters associated with the critical update.

23. The non-transitory computer readable storage medium of claim 22, the operations further comprising encoding the one or more management frames to include an indication to signal that all UHR critical update parameters associated with the critical update are included in the one or more management frames.

24. The non-transitory computer readable storage medium of claim 21 wherein the generation update type value indicates an update relevant to a wireless standard generation.

25. The non-transitory computer readable storage medium of claim 21, wherein the one or more management frames are beacon frames.

26. The non-transitory computer readable storage medium of claim 21 wherein the one or more management frames are probe response frames, association response frames, or (re)association response frames.

27. The non-transitory computer readable storage medium of claim 21 wherein the UHR critical update information field is included in a common info field in the basic multi-link element and wherein the basic multi-link element further includes a presence bitmap subfield, the presence bitmap subfield comprising a presence bit indicating a presence of the UHR critical update information field in the common info field.

28. The non-transitory computer readable storage medium of claim 21, the operations further comprising:
receiving, by the affiliated AP, an indication of a critical update to a UHR mode of operation affecting a second affiliated AP of the AP MLD;
responsive to the indication of a critical update to a UHR mode of operation affecting a second affiliated AP of the AP MLD:
setting the value of the UHR critical update flag to indicate a critical update;
incrementing a UHR BSS Parameters Change Count (BPCC) value corresponding to the second affiliated AP; and
encoding the one or more management frames to include the UHR critical update flag and a reduced neighbor report element, the reduced neighbor report element including a second UHR critical update information field, the second UHR critical update information field comprising the UHR BPCC value corresponding to the second affiliated AP and a generation update type value.

29. The non-transitory computer readable storage medium of claim 21, the operations further comprising:
receiving an indication of a critical update to a UHR mode of operation for a second affiliated AP of the AP MLD;
incrementing a UHR BSS Parameters Change Count (BPCC) value corresponding to the second affiliated AP;
encoding the one or more management frames to include the UHR critical update flag and a basic multi-link element including a second UHR critical update information field for the second affiliated AP, the UHR critical update information field comprising the UHR BPCC value and a generation update type value; and
transmitting, by the affiliated AP, the one or more encoded management frames.

30. The non-transitory computer readable storage medium of claim 29, wherein the second UHR critical update information field is included in a STA Info field in a per-STA Profile sub-element of the basic multi-link element and wherein a STA Control field in the per-STA Profile sub-element in the basic multi-link element further includes a presence bit indicating a presence of the second UHR critical update information field in the STA Info field.
